(19) United States
(12) Patent Application Publication
(10) Pub. No.: US 2022/0346325 A1
(43) Pub. Date: Nov. 3, 2022

(54) METHOD FOR GRIPPING AND REMOVING THE TIE MEANS FROM A BALE AND MACHINE INTENDED TO LOAD, SHRED, DISTRIBUTE AND/OR TRANSFORM SUCH A BALE AND FITTED WITH A GRIP AND A REMOVAL DEVICE

(71) Applicant: KUHN-AUDUREAU SAS, La Copechagniere (FR)

(72) Inventors: Pascal GAUTRON, Saint-Fulgent (FR); Christophe ROGER, La Roche-Sur-Yon (FR)

(73) Assignee: KUHN-AUDUREAU SAS, La Copechagniere (FR)

(21) Appl. No.: 17/660,864

(22) Filed: Apr. 27, 2022

(30) Foreign Application Priority Data
Apr. 28, 2021 (FR) 21 04429

(51) Int. Cl. A01F 29/09; B65B 69/00

(52) U.S. Cl. CPC A01F 29/09; B65B 69/0025

(57) ABSTRACT

The present invention is a method for gripping and removing the tie means from a bale loaded in a machine intended to load, shred, distribute and/or transform such a bale held in shape by a tie means extending around its outer surface. It involves, using such a machine furthermore including a grip and removal device including a grip means and removal means, moving the grip means from a first position remote from the outer surface of the bale to a second position on the outer surface, then gripping the latter using the grip means and removing the tie means by moving it away from the outer surface. Its subject is also such a machine suitable for the implementation of the said method.

### BACKGROUND OF THE INVENTION

### Field of the Invention

The present invention concerns the field of livestock breeding, or the manufacturing of pellets used particularly as a fuel source, from cylindrical or rectangular cuboid bales of straw, hay or similar products and more specifically the field of machines intended for loading, shredding, distributing and/or transforming such bales. Its subject is a method for gripping and removing the tie means from a cylindrical or rectangular cuboid bale loaded in a machine intended to load, shred, distribute and/or transform such a bale. Its subject is also such a machine.

### Description of the Related Art

When livestock has no access to pastures, it is fed from stock or fodder reserves taken from forage areas for mowing. The cut grass is harvested after a few days drying time using a baler to pack it into bales, also known as bundles, in cylindrical or rectangular cuboid shape.

The thus produced bales are stored and used when required, in the form of fodder for feeding livestock. The farmer also uses straw packed in bales to carry out the bedding for animals.

The bales are surrounded by or belted with a tie means made of one or more tie(s) to keep them in shape, i.e. a compacted shape suitable for their handling and storage and/or protection. The tie means includes one or more ties, generally of the string-type, wrapped one or more times around the bale to compact and tie together the product(s) forming the bale. Other ties, of the net, film or protective covering-type, are also used to provide such a tie means. Because of the material of the bale, the tie means, in particular of the string or net-type, extends on the outer surface of the bale, i.e. on the outer surface and/or in the thickness (or the material) of the bale near the outer surface.

The tie means extends around all or part of the outer surface of the bale. In the case of a cylindrical bale, for example, the tie means extends usually only around its outer cylindrical surface between its two circular ends or sides, i.e. without extending around the circular ends.

Several types of machines are used to process such bales, whether it be to spread the straw and carry out the bedding, to mix and/or distribute fodder or, in another field than that of livestock breeding, to convert such a bale by unpacking it and shredding it to make pellets, usually in cylindrical shape, used in particular as a fuel source in heating systems. Such machines are therefore of the straw-bedder type or of the type for the manufacturing of pellets, used in particular as a fuel source.

A straw-bedder type machine has a receptacle to receive the bale, an unraveling-type rotary element, a means for conveying the bale towards the rotary element and possibly a loading and bale conveying door. The bale is placed in the receptacle, equipped or not with side walls, to be shredded and spread on the ground in a swath on the feeding plate or to be spread widely across the ground surface using a turbine that throws out the straw at several meters. The conveying means is placed inside the receptacle and consists, for example, of a chain conveyor belt with strips. The door is fitted on the reservoir in an articulated manner, moving between a loading position and a transfer position for the bale in the receptacle. The loading door enables the cylindrical bale to be moved so as to release the tie means and to make its removal easier.

Such a receptacle is also present on a machine for the manufacturing of pellets, in particular used as a fuel source. The fixed or stationary platform-type machine makes it possible to unpack or shred a straw bale to produce such pellets.

Nevertheless, before undertaking the processing of a bale loaded in the receptacle, the tie means must be removed. This operation is generally carried out firstly during a cutting operation consisting in cutting the tie means, and then, in a second stage by pulling on the latter to take it off the bale and remove it.

Usually, these cutting and withdrawal operations are performed manually. Cutting is carried out with a knife or a cutter and withdrawal is done by grasping the tie means manually. The tie means must be cut across the entire width of the bale and the cut tie means, consequently split into several ties, must then be separated and removed. Withdrawal of the ties is done individually or by grouping several ties, depending on the difficulty involved in pulling to remove the ties as the weight of several hundred kilograms of the bale rests on the cut tie means. These daily manual operations are tiresome for the operator. Furthermore, they are often performed once the bale has been placed in the machine, where access to the tie means is limited especially, where applicable, by the presence of the side walls of the receptacle and sometimes requiring a walkway. This removal operation is performed in a position that is often uncomfortable for the operator.

In order to overcome part of the drawbacks, the document FR3089385 proposes a cutting device placed at the bottom of the machine to cut the ties when the bale is loaded. The cutting device operates in the bottom part and across the entire width of the bale. Nevertheless, after mechanical cutting of the tie means, the latter must still be manually taken off and removed by the operator.

The document FR3084239 proposes a solution in which the cut tie means is manually wound around a vertical drum winch. However, whilst removal of the tie means is easier thanks to the winch, the operator must still, after cutting the tie means, separate the various ties from the bale and remove them partially in order to wind, for at least one turn, the tie means around the drum by pulling on the free end of the tie means, then the operator must control the rotation of the winch to remove the tie means and collect it on the drum. With such a solution, it always remains at least one action that must be performed manually by the operator to grip the tie means in order to fully remove it by the winch.

### SUMMARY OF THE INVENTION

The purpose of the present invention is to overcome these drawbacks by proposing a method for gripping and removing the tie means of a cylindrical or rectangular cuboid bale loaded in a machine and such a machine suitable for the implementation of the method.

To achieve this, the method for gripping and removing the tie means of a cylindrical or rectangular cuboid bale loaded in a machine intended to load, shred, distribute and/or transform such a bale, the machine including a receptacle and a receiving area on which such a bale rests, which is held in shape by a tie means extending around the outer surface of the bale, is characterized in that it consists, using such a machine furthermore including a device for gripping and removing the tie means, the device including a grip means and removal means, following a cutting step for the tie means:
in a grip step: moving the grip means from a first position remote from the outer surface of the bale to a second position at the level of the outer surface where the tie means extends, then to grip the tie means using the grip means,
in a removal step: removing the tie means from the bale using the removal means by moving it away from the outer surface of the bale.

The machine, according to the present invention, intended to load, shred, distribute and/or transform a cylindrical or rectangular cuboid bale held in shape by a tie means extending around the outer surface of the bale, the machine including a receptacle and a receiving area, is substantially characterized in that it also includes a device for gripping and removing the tie means, including:
a grip means configured to be able to grip the tie means of such a bale resting on the receiving area,
removal means configured to be able to operate on the tie means in such a way as to be able to remove it from the bale by moving it away from its outer surface,

and being configured to be able to move the grip means above the receiving area between a first position enabling it to be moved away from the outer surface of the bale and a second position enabling it, in order to grip the tie means, to be positioned at the level of the outer surface.

### BRIEF DESCRIPTION OF THE DRAWINGS

The invention will be better understood from the following description, which refers to a preferred embodiment given as a non-limiting example and explained with reference to the attached schematic drawings, in which:

FIG. 1 is a side view of a machine according to the present invention, of the straw-bedder type, showing a cylindrical bale (solid line) or rectangular cuboid bale (dotted line) loaded in the machine on a receiving area formed by the door of the receptacle in the open position at the rear of the machine,

FIG. 2 is a perspective view of the rear part of the machine shown in FIG. 1, at the start of the grip step where the grip means is moving into its second position,

FIG. 3 is a partial perspective view of the rear part of the machine shown in FIG. 2, when the grip means extends around the outer surface of the bale,

FIG. 4 shows the machine shown in FIG. 3, at the end of the grip step when the grip means has been operated to change state and move to the grip or closed state, gripping the tie means,

FIG. 5 shows the machine shown in FIG. 4, at the start of the removal step when the grip means is moved away from the outer surface of the bale above the latter,

FIG. 6 is a rear view of the machine shown in FIG. 5 and in the same configuration,

FIG. 7 shows the machine shown in FIG. 5 in a later phase of the removal step when the tie means, gripped by the grip means, has been shifted onto one side of the machine,

FIG. 8 is a partial perspective side view of the machine shown in FIG. 1, in a final phase of the removal step enabling the complete removal of the tie means by winding on a rotary plate,

FIG. 9 shows the machine shown in FIG. 8, in a step of releasing the tie means wound onto the rotary plate by withdrawal of the winding pins,

FIG. 10 is a front view of the double comb of the grip means of the machine according to the present invention shown in FIG. 2, in the expecting or open state of the double comb located above the outer surface of the top of the bale,

FIG. 11 shows the double comb of FIG. 10 in an operation phase of the machine as shown in FIG. 3, acting on the outer surface of the top of the bale, in the expecting or open state of the double comb,

FIG. 12 shows the double comb shown in FIG. 11 and operated in the grip or closed state, with the tie means trapped in the closed spaces of the double comb,

FIG. 13 is a perspective view of a claw-shaped element included in the grip means in another embodiment and acting on the bottom of the bale beneath the latter.

### DETAILED DESCRIPTION OF THE PREFERRED EMBODIMENTS

The attached figures show a machine intended to load, shred, distribute and/or transform a cylindrical or rectangular cuboid bale B held in shape by a tie means L extending around the outer surface S of the bale B, the machine including a receptacle C and a receiving area P1.

In accordance with the present invention, such a machine additionally includes a device for gripping and removing the tie means L, including:
a grip means 1 configured to be able to grip the tie means L of such a bale B resting on the receiving area P1,
removal means configured to be able to operate on the tying means L in such a way as to be able to remove it from the bale B by moving it away from its outer surface S.

Still in accordance with the present invention, the grip and removal means is configured to be able to move the grip means 1 above the receiving area P1 between a first position enabling it to be moved away from the outer surface S of the bale B and a second position enabling it, in order to grip the tie means L, to be positioned at the level of the outer surface S.

Thanks to these features, the gripping and removal operations are operated by mechanical means. Advantageously, the gripping operation and the removal operation are each carried out without the need for any intervention by the operator. They are said to be automatic, they are carried out without the operator needing to be present directly next to the machine. The operator may stay or climb into the cab of his/her tractor. Since these operations are mechanized, they are therefore less arduous for the operator. Advantageously, the grip and removal device for the tie means L is automatic, i.e. it enables at least the automatic gripping of the tie means L. Furthermore, the grip and removal device for the tie means L enables the tie means L to be automatically taken off/removed at least partially from the bale B. This involves separating the tie means L, which has been cut beforehand, from the bale B, to avoid malfunctions and machine failures due to the introduction of a tie means L or a fragment of a tie means L in the machine. Preferably, this device enables the tie means L to be automatically taken off/removed completely such that the tie means L is no longer in contact with the bale B, which then has no tying tie L and can be processed by the machine.

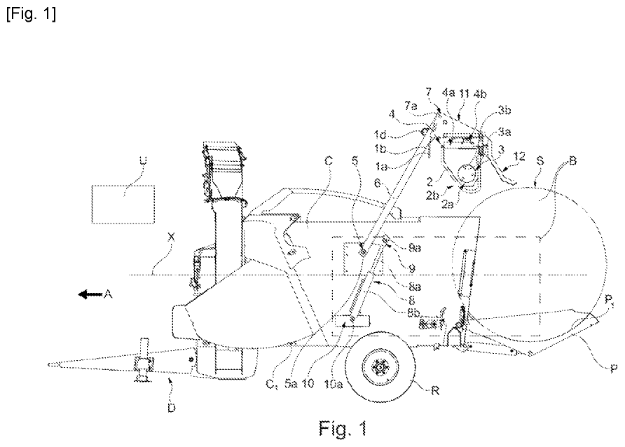

Advantageously, the receiving area P1 extends at least partially at the rear of the receptacle C. Preferably, the receiving area P1 may be formed, as can be seen in FIGS. 1, 2, 6 and 7, by the door P of the receptacle C, in the open position of the door P, more specifically at the rear of the machine. The receiving area P1 is more specifically formed by the inner side of the door P. In the embodiment example shown in FIG. 1, the receiving area P1 (inner side) has a straight part and a curved part. The curved part provides a support face for the cylindrical bale whereas the straight part provides a support face for the rectangular cuboid bale (dotted line). The door P, in the open position, forms an extension of the bottom C1 of the receptacle C towards the outside. This door P enables loading of a cylindrical bale B in the machine; it is controlled by an actuator. In another embodiment, not shown, the receiving area P1 may be formed directly by the bottom C1 of the receptacle C.

Outer surface S of the bale B means an outer layer of material including the outer surface S and a thickness of material beneath and next to the outer surface S. It is then understood that the tie means L may extend at the level of the outer surface S by extending around the outer surface S and/or in the thickness (or the material) of the bale B next to the outer surface S. It is also understood that in its second position, at the level of the outer surface S, the grip means 1 may extend or penetrate into the outer layer, i.e. in the thickness (or the material) of the bale B (FIGS. 3, 4, 11 and 12).

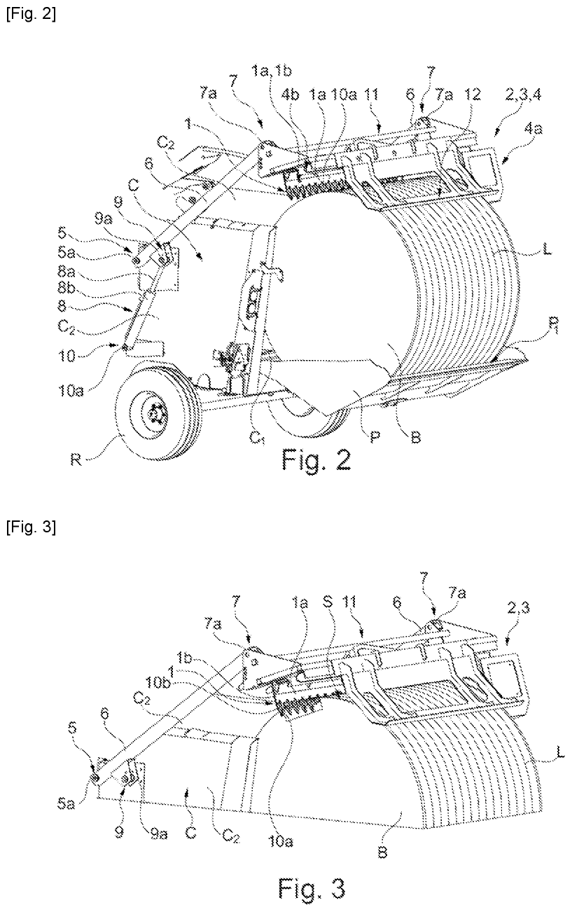

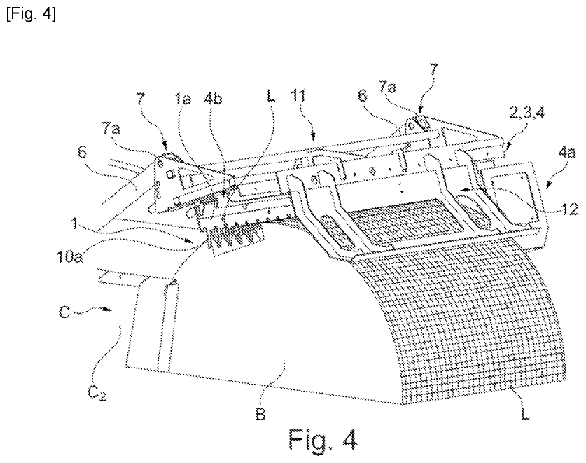

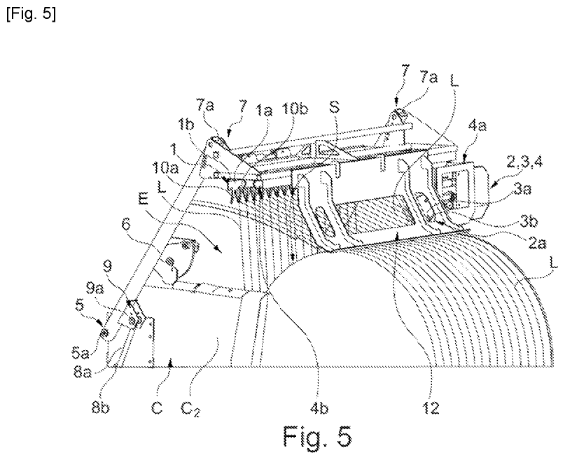

The tie means L may extend around all or part of the outer surface S of the bale B. For example, as can be seen particularly in FIGS. 2, 3 and 5, for a cylindrical bale B, as is usually the case, in particular for a string-type tie means, the tie means L may extend around its outer cylindrical surface S between its two circular ends, i.e. without extending at the level of the circular ends. The cylindrical bale B shown in FIG. 4 has a net-type tie means. This type of tie means L (net) may cover the circular end close to the outer surface S of the bale B over a few centimeters (not visible in FIG. 4).

The bale B is formed by a baler that gathers and conditions the swaths of hay or straw. The bale B is formed in the press or compressing chamber of the baler and a tying system applies the tie means L; for example, one or several ties or layers around the bale B. Thanks to this tie means L, the shape of the bale is kept. The purpose of the baler is to produce dense, stable and uniform bales or bundles of fodder, which are then easy to handle and store. The tie means L surrounds the bale B in its compressed shape taken in the pressing chamber. It extends at least over a part of the outer surface of the bale. The tie means L compresses and ties together the fodder making up the bale B. The tie means enables the bale B to be conditioned so that it keeps its compressed shape. The tie means L is applied over at least the entire width of the bale B to limit losses and to ensure that all the fodder is/remains in the bale B. The tie means L is for example of the string, net or film-type. The sides of the bale B, on either side of the outer surface S, have no tie means L. The grip and removal device of the invention is intended to grip and remove the tie means L present on the outer surface S of the bale B, i.e. on the outer surface S and/or in the thickness of the bale B near the outer surface S. The device of the invention is able and is intended to grip the tie means L that at least partially covers the outer surface S of the bale B. The device of the invention does not operate on the sides of the bale B since the tie means L does not extend on the sides or does not cover the sides. The device of the invention is not intended to operate on a wrapped bale, i.e. when the bale is completely covered with plastic film so that the fodder—in this case, grass—is deprived of oxygen. Such a wrapped bale is hermetically sealed since the outer surface S as well as the sides are covered with several layers of plastic film.

For a round baler, the shape of the bale is cylindrical and the tie means L is applied on the cylindrical surface of the bale B. The sides or circular ends of the bale B have no tie means L. When the tie means L is of the string-type, several strings or loops of string are applied around the bale B to enable it to keep its shape. The string is distributed across the cylindrical surface of the bale B in order to keep the cylindrical bale perfectly compressed. When using film or net, several layers are applied to the cylindrical surface or around its cylindrical surface in order to keep its compressed shape. The net or film may cover the entire width of the cylindrical surface of the bale or at least a large part of its width. For rectangular cuboid bales, the tying system or knotting device of the high-density baler applies several strings or ties (tie means L) on the outer surface S of the bale B. Given the high level of compression of the fodder, the strings used are generally thicker. The tie means L surrounds the four sides of the rectangular cuboid bale. These four sides form the outer surface S of the rectangular cuboid bale. The two other sides of the rectangular cuboid bale are not fitted with tie means L.

When the bale B is cylindrical in shape, it is preferably positioned on the receiving area P1 (formed, for example, by a curved part in the door P) such that its both circular ends are substantially parallel to the sides of the receptacle C or of the machine and/or to the direction of travel A of the machine and/or to the longitudinal axis X of the machine.

The machine, in particular the receptacle C or a chassis of the machine carrying the receptacle C, may be fitted with a hitching system enabling it to be mounted on a tractor at its three-point hitch. As a variant, as shown in FIG. 1, the machine, more specifically the receptacle C, may be mounted on a rolling chassis F, including wheels R, such that it may be pulled by its coupling end D, at the rear of a tractor vehicle (not shown).

Such a machine according to the present invention, may be used for many applications, for example to spread the straw and carry out the bedding, to mix and/or distribute fodder or even, in another field than that of livestock breeding, to decompress or shred such a straw bale to produce pellets to be used, for example, in heating systems.

Where the machine, according to the present invention, is of the type straw-bedder, as can be seen particularly in FIGS. 1 to 9, it may include an unraveling-type rotary element, a conveying means for moving the bale B towards the rotary element and possibly, a loading and bale conveying door P for the bale B. The bale B is notably placed in the receptacle C, fitted with side walls C2, to be shred and spread on the ground on a swath on a feeding plate or spread widely across the ground surface using a turbine that throws the straw several meters away. The conveying means is placed in the receptacle C and may be a chain conveyor belt, for example with strips. Alternatively, the conveying means is a belt conveyor. The door P may be fitted in an articulated manner on the receptacle C, for example at the rear of the machine or the receptacle C, moving between a loading position and a conveying position for the bale B in the receptacle C. The loading door P enables the bale B to be moved in order to release the tie means L and to make its removal easier. The loading position of the door P may be the position in which the bale B can rest on the door in order to carry out gripping and removal of the tie means L, according to the present invention. It is noted in particular in FIG. 1 that when a rectangular cuboid bale B is loaded in the machine, it extends partially in the receptacle C and on the door P due to its length. It rests on the conveying means and on the straight part of the receiving area P1.

The receptacle C may be fitted (FIGS. 1 to 9) or not with side walls C2. The straw-bedder shown in FIG. 1 is fitted with side walls C2 enabling the bale to be guided towards the unraveling-type rotary element. The side walls C2 also enable the bale B to be held in the receptacle C such that, for example, the straw it contains does not fall out of the machine and can be completed processed.

In a preferred embodiment of the grip means 1, the latter may be configured to be able to change state, so that it can switch when operated from an expecting state to a grip state and vice-versa, the grip state enabling the tie means L to be gripped.

Preferably, the grip means 1 may be configured to be able to grip the tie means L by pinching, trapping, clamping or hooking.

In the expecting state, the grip means 1 may be placed in an open state, able to gather the tie means L and in the grip state, the tie means 1 may be placed in closed (or shut) state, able to trap, clamp or pinch the tie means L.

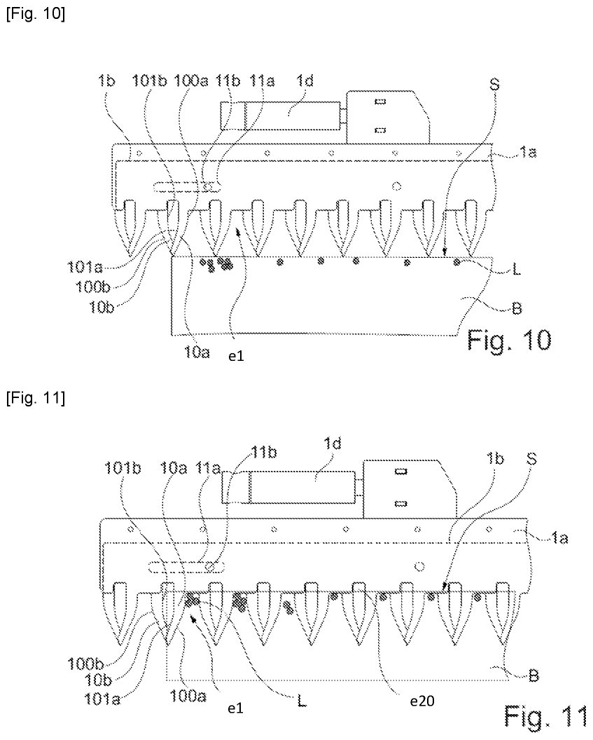

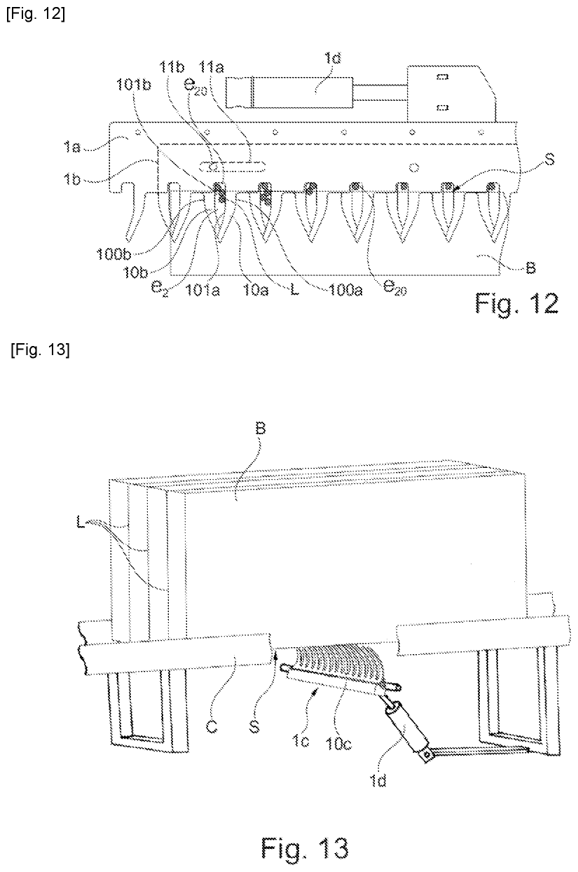

The grip means 1 may switch from the expecting or open state (FIGS. 10 and 11) to the grip or closed state (FIG. 12) when the grip means 1 is in its second position on the outer surface S of the bale B, where applicable by penetrating or extending into the thickness (or the material) of the bale B (FIG. 3), to grip the tie means L.

FIGS. 10 to 12 show, at a larger scale than FIGS. 2 to 4 respectively, a part of the grip means 1 and a part of the outer surface S of the bale B with the tie means L of the string-type shown schematically. In practice, the various loops, which form the ties, of the tie means L that are wrapped around the bale B remain “hidden” at the outer surface S of the bale B, even after having been cut, since they put pressure on the product/material (straw, hay) constituting the bale B in order to keep its shape.

In a preferred embodiment, when the grip means 1 is configured to be able to change state, the tie means 1 may be configured to form, in the expecting or open state, open spaces e1 able to gather the tie means L (FIG. 10); i.e. the part of the tie means L meeting the grip means 1 and, in the grip or closed state (FIG. 12), closed (or shut) spaces e2, for example, in the shape of eyelets, in which the tie means L is trapped, with the result of being gripped.

Switching of the grip means 1 between the expecting or open state (FIG. 10) and the grip or closed state (FIG. 12) may correspond to a transitional state (not shown), active or not.

Still in the preferred embodiment, when the grip means 1 is configured to be able to change state, the grip means 1 may include at least one movable grip element 1a, 1b, 1c able, when the grip means 1 switches from the expecting state to the grip state, to be moved in translation, preferably in rectilinear translation (see in particular FIGS. 2 to 7, 10, 11, 12) or according to another trajectory, for example helical. The trajectory, e.g. helical, of the concerned movable grip element 1c may take place in the bottom part of the bale B beneath the latter.

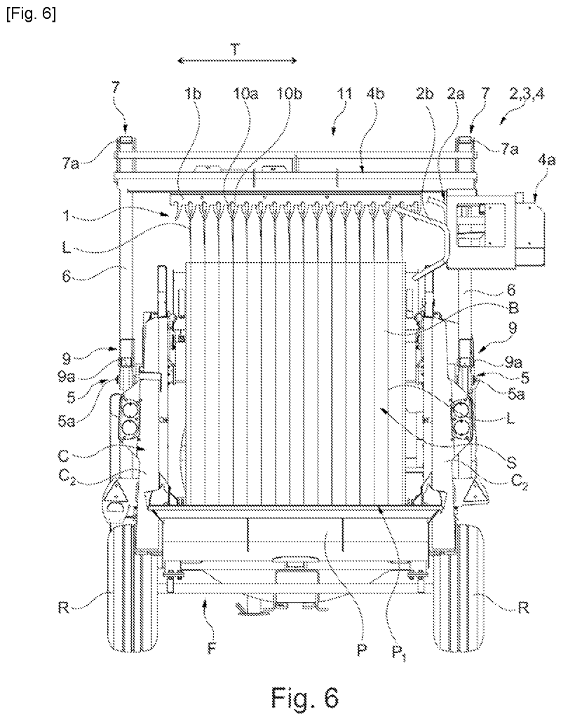

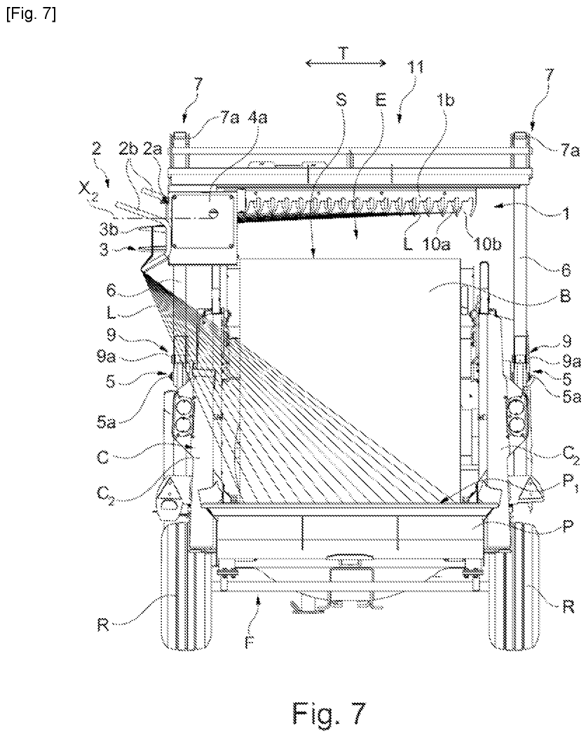

According to the embodiment example shown, the grip means 1 extends transversally in relation to the direction of travel A and substantially across the width of the machine (FIGS. 6 and 7). As can be seen more specifically in FIGS. 6, 7 and 10 to 12, when the grip means 1 includes at least one grip element 1a, 1 b movable in rectilinear translation, the grip means 1, in a preferred embodiment, may include a double comb featuring two combs 1a, 1b fitted with a series of teeth 10a, 10b able to penetrate the thickness of the bale B. It is also noted that, in the case of a cylindrical bale as shown in FIG. 6, preferably the combs 1a, 1b go or extend beyond the circular ends. In this way, one can make sure that all the ties of the tie means L are gripped at the same time. Both combs 1a, 1b run parallel one behind the other, and at least one of the combs 1a, 1b forms the or one of the movable grip element(s). At least one of the combs 1a, 1b, preferably each comb 1a, 1b, is movable in rectilinear translation in relation to the other, following the direction of its longitudinal axis. In FIGS. 11 and 12, one can see that the teeth 10a and 10b have penetrated the thickness of the bale B. With this grip and removal device, all the ties of the tie means L are gripped simultaneously across the width of the bale B, which saves time with respect to a manual and individual gripping of each tie. Alternatively, and not shown, the at least one grip element forming the grip means 1 is made of several sections.

In order to enable translational guidance of the two combs 1a, 1b with respect to one another, one of the two combs 1b may include at least one slide 11b and the other comb 1a may include at least one longitudinal slot 11a in which the slide 11b may run (FIGS. 10, 11, 12).

The or each comb 1a, 1b forming the or one of the movable grip element(s) 1a, 1b of the grip means 1 may be operated in motion by an actuator 1d, for example of the jack-type which the grip means 1 may comprise (FIG. 1). Where one of the two combs 1a, 1b is not made movable, it then forms a fixed grip element in relation to the other movable comb 1a, 1b.

With the grip means 1 in expecting or open state, the shape of the teeth 10a, 10b may be defined such that two successive teeth 10a, 10b of the two respective combs 1a, 1b may form together an open space e1 able of gathering the tie means L (FIG. 11), i.e. the part of the tie means L met by the combs 1a, 1b in the expecting position. The shape of the teeth 10a, 10b is also defined such that, in the grip or closed state of the grip means 1, two successive teeth 10a, 10b of the two respective combs 1a, 1b may form together a closed space e2, for example, in the shape of an eyelet, able of trapping the tie means L (FIG. 12), i.e. the part of the tie means L inserted in the open spaces e1 in the expecting or open state. The shape of a tooth 10a, 10b is preferably curved, for example arch-shaped, in the plane of the comb 1a, 1b. Each tooth 10a, 10b can therefore have an outer face 100a, 100b (or extrados) and an inner face 101a, 101b (or intrados). The curvature makes it advantageously possible to guide the tie means L in the open spaces e1 between the teeth 10a, 10b.

As can also be seen in FIGS. 10, 11 and 12, the curvature of one of the combs 1a may be inverted compared with the curvature of the other comb 1b such that each closed space e2 is defined by the space demarcated between the inner face 101a of a tooth 10a belonging to one of the two combs 1a and the inner face 101b of a tooth 10b belonging to the other comb 1b (FIG. 12). The open space e1 is defined by the space demarcated between the outer face 100a of a tooth 10a belonging to one of the two combs 1a and the outer face 100b of a tooth 10b belonging to the other comb 1b (FIG. 11).

In the expecting or open state of the grip means 1, the recessed areas of the two combs 1a, 1b may then be superimposed and form a part of the closed space e2 between two teeth 10a, 10b (FIG. 11). The same applies in the grip or closed state, the recessed areas may be superimposed (FIG. 12). They may thus gather the tie means L. In the transitional configuration of the grip means 1, the recessed areas may block one another. In the grip or closed state (FIG. 12), the closed space e2 may form a volume (or a passage or an opening), for example in the shape of an eyelet, through which the tie means L can pass, for example one or more tie(s) forming the tie means L when this is of the net-type.

Consequently, when the grip means 1 switches from the expecting or open state (FIG. 11) to the grip or closed state (FIG. 12), the rectilinear translation of at least one of the two combs 1a, 1b in the axis of the double comb 1a, 1b traps the tie means L in the closed spaces e2 between two teeth 10a, 10b and grips the tie means to remove it (FIG. 12).

Advantageously, the volume of the closed space e2 between two teeth 10a, 10b in the grip or closed state (FIG. 12) is greater than or equal to the volume of the open space e1 between two teeth 10a, 10b in the expecting or open state (FIG. 11). Particularly advantageously, the closed space e2 is fitted with an additional space e20 compared with the open space e1. This additional space e20 is an enlargement height-wise to create a storage area for the tie means L or ties of the latter to avoid them escaping during gripping, i.e. when the combs 1a, 1b change state.

One refers now to FIG. 13, which shows the embodiment example of a machine for producing pellets used in particular as a fuel source. Before entering the machine that shreds the straw bale B to reprocess it as pellets, the tie means L surrounding the rectangular cuboid bale B must be removed. In the example, the machine includes a receptacle C or platform with a reference area P1 intended to receive the bale B, the rectangular cuboid bale shown is wrapped by three ties of the tie means L. This machine is placed/set down on the ground. It includes a grip and removal device according to the invention, which is placed beneath the bale B and under the receptacle C. Only the grip means 1 is shown in the form of at least one grip element 1c movable following a trajectory other than a translational movement, for example, a helical trajectory. In this specific embodiment of the grip means 1, the movable grip element 1c may be claw-shaped or a cross-member, fitted with teeth 10c (FIG. 13). Preferably, such a grip element 1c extends transversally underneath the bale B and preferably has a width substantially equal to the width of the bale B. Such a movable grip element 1c may be operated using an actuator 1d, for example of the jack-type. The removal means are not shown in this figure.

With reference to FIGS. 1 to 9, one can see that the grip and removal device may be fitted in an articulated manner on the receptacle C and may include therefore at least one joint 5 including at least one swivel axis 5a, preferably at least one horizontal swivel axis 5a, and at least one arm 6, preferably two arms 6, pivoting around the or one of the swivel axes 5a and carrying at least the grip means 1 such that they may be moved into the first position and into the second position. Preferably, the swiveling arm(s) 6 may be fitted to support or carry the grip means and the removal means as can be seen in FIGS. 1 to 9. Both swiveling arms 6 may be, preferably, placed on each side of the receptacle C or the machine. Horizontal swivel axis 5a means a swivel axis 5a extending horizontally or parallel to the ground surface on which the machine moves or is placed. Preferably, each swivel axis 5a may extend transversally to the direction of travel A of the machine or to the longitudinal axis X of the machine. Preferably, each joint 5 may be fitted on one of the opposite side walls C2 of the receptacle C, preferably on the outer face of the concerned side wall C2, when the receptacle C includes such opposite side walls C2. Each joint 5 may also be fitted on another part of the machine, which may be separate from the receptacle C.

Each swiveling arm 6 may be operated by an actuator 8, for example of the jack-type (see particularly FIGS. 1, 2, 5 to 9). Such an actuator 8 may be fitted in an articulated manner on the receptacle C and on the arm 6. The jack-type actuator 8 may then be articulated, via its rod 8a, on the arm 6 by a first joint 9 and, via its cylinder 8b, on the receptacle C, for example on one of its side walls C2, by a second joint 10. Preferably, the first joint 9 may be located next to the joint 5 of the arm 6 on the receptacle C. The first and second joints 9, 10 may each include a swivel axis 9a, 10a, preferably parallel to the swivel axis 5a of the joint 5 of the swiveling arm(s) 6.

Travel, more specifically swiveling, thanks to the swiveling arm(s) 6, of the grip means 1, may be done so that the outer surface of the bale B is reached at the top or bottom of the bale and/or coming from above (FIGS. 1 to 9) or from underneath the bale B as shown in FIG. 13. For the mechanization of the preliminary gripping operation, it is known to use a built-in cutting device, for example in the door P, at the curved part, which will make it possible to cut the tie means L of a cylindrical bale B in the case of a straw-bedder. Alternatively, the cutting device is provided at the level of the receptacle C for the rectangular cuboid bales B.

Each swiveling arm 6 may support the grip means 1 and, where applicable, the removal means via a transverse support rail 11 that may also be included in the device. Consequently, each swiveling arm 6 may be fitted in an articulated manner, on the one hand, at one end of its ends, via the joint 5, on the receptacle C and, on another hand, at its other end, via a joint 7, on the support rail 11. The or each joint 7 on the support rail 11 may include a swivel axis 7a, preferably parallel to the swivel axis 5a of the joint 5 of the arm 6 on the receptacle C (FIGS. 1 to 9).

In a preferred embodiment of the removal means, the latter may include, as can be seen in FIGS. 1 to 9, shifting means 2 able of being moved and configured so that they can, when moving, apply against the tie means L such that it is shifted onto or beyond one side of the receptacle C or of the machine. “On one side” means a shifting position substantially at the level of, withdrawn from or beyond the concerned side (side wall C2) of the receptacle C or of the machine. “Beyond one side” means a shifting position remote from the side. Advantageously, the removal of the tie means L is performed on the left-hand side of the machine or of the receptacle C (given the direction of travel A). The left-hand side is more practical because normally the operator gets out of the tractor cab on the left. Alternatively, the removal of the tie means L is performed on the right-hand side of the machine.

Preferably, in order to be able to perform this movement, the removal means may also include a drive system 4 making it possible to ensure the travel of the shifting means 2. The drive system 4 may preferably include a drive carriage 4a movable in translation, preferably in rectilinear translation, from one side to the other of the receptacle C or the machine. It is understood that the carriage 4a may be moved between two opposite sides of the receptacle C or of the machine or beyond at least one of the sides of the receptacle C or of the machine (FIG. 7). The shifting means 2 may then be rigidly fastened to the movable drive carriage 4a. Furthermore, the shifting means 2 may include guides 2b making it possible to collect, group together and guide the tie means L meeting the shifting means 2 during their travel. The shifting means 2 may operate without such guides 2b but do less efficiently.

The travel may be provide for the shifting means 2 when the grip means 1 is moved into its first position in such a way as to leave a space E, between the latter and the outer surface S, for example the outer cylindrical surface S of the bale B, enabling the passage of the shifting means 2, where applicable of the drive carriage 4a carrying the latter means (see in particular FIG. 7). It is understood that the first position can therefore be determined to leave such a clearance space E for the shifting means 2 between the grip means 1 and the outer surface S of the bale B.

In a preferred embodiment, as can be seen in FIGS. 1 to 9, the shifting means 2 may include a shifting plate 2a, preferably oriented transversally to the travel direction T of the shifting means 2. Preferably, the shifting means 2 may furthermore include the guides 2b. Consequently, during travel of the shifting means 2, the tie means L may be guided by the guides 2b towards and against the shifting plate 2a to ensure it is shifted efficiently onto or beyond one side of the receptacle C or of the machine (see particularly FIG. 7). With such a grip and removal device, the withdrawal operation of the tie means L of the bale B is made considerably easier and brings comfort to the operator since the tie means L is gathered on one side of the receptacle C (FIG. 7). The operator can then grip the tie means L (or all of the tie means L) quickly and remove it (them) (completely).

Preferably, the drive carriage 4a may be made movable in translation in a direction T, transverse or perpendicular in relation to the direction of travel A of the machine or to the longitudinal axis X of the machine. The shifting means 2 are then moved in the direction T.

In order to be able to guide the movement of the carriage 4a, the drive system 4 may include guide means 4b for the drive to the drive carriage 4a, of the guide rail-type, and operating means 4c of the rack-and-pinion, actuator, jack, cable or chain-type.

In a specific embodiment, not shown in the attached figures, of the removal means those may be configured, especially by their positioning and/or their range and/or their travel trajectory, such that the shifting means 2 may completely remove the tie means L when the latter has been shifted, i.e. it is no longer necessary to perform another removal operation, be it manually or automatically. The drive system 4 may then be, for example, a drive arm carrying the shifting means 2 and completely moving away, through its travel, the tie means L from the outer surface S of the bale B on or beyond one side of the receptacle C or the machine. In another embodiment, without the drive arm, the drive system 4 may include the drive carriage 4a described previously and may be configured so that the drive carriage 4a may be moved over a sufficient distance to completely move the tie means L away from the outer surface S of the bale B.

In another embodiment shown in the attached figures (see particularly FIGS. 1 to 9) not enabling the shifting means 2 to completely remove the tie means L once this has been shifted, the removal means may furthermore include withdrawal means 3 making it possible to (completely) remove the tie means L from the bale B, preferably by winding around a winding axis X2, preferably a horizontal winding axis X2 (see particularly FIGS. 1 to 9). These withdrawal means 3 may be operated when the tie means L has been shifted or during shifting.

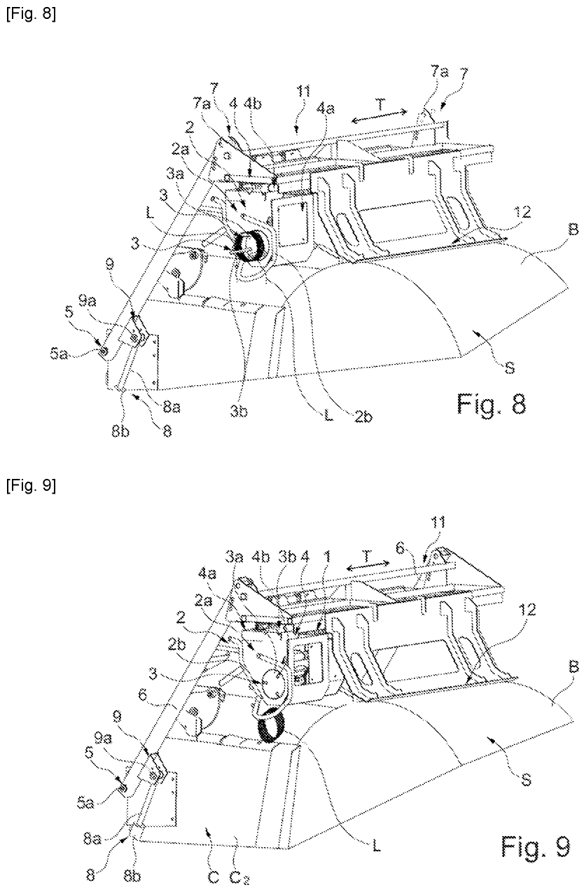

Such withdrawal means 3 by winding may consist of a winder (visible in FIGS. 8 and 9), preferably rigidly fastened to the shifting means 2, where applicable, of the drive carriage 4a. The winder may be configured to be able to wind the tie means L around a winding axis X2, preferably horizontal. Horizontal winding axis X2 means a winding axis X2 extending horizontally and/or parallel to the bottom C1 of the receptacle C and/or parallel to the ground surface on which the machine is placed or moves.

With reference to FIGS. 1 to 9, one can see that the winder 3 may include, in a preferred embodiment, a rotary plate 3a, for example in the shape of a disc, and at least two winding pins 3b, preferably three winding pins 3b rigidly fastened in rotation to the plate 3a and protruding from the plate 3a, preferably perpendicularly to the latter, in order to be able to hook the tie means L and to wind it around the pins 3b when the plate 3a rotates. The rotary plate 3a is fitted in rotation around the winding axis X2.

In a preferred embodiment, the rotary plate 3a may constitute a movable part of the shifting plate 2a of the shifting means (see particularly FIGS. 1, 5, 8, 9). The shifting plate 2a thus includes a fixed part and a movable part formed by the rotary plate 3a. It is therefore understood that the winding pins 3b protrude from the shifting plate 2a against which the tie means L is shifted.

Preferably, the winding pins 3b may be fitted in a retractable way in the rotary plate 3a so that they may be moved into a retracted or tucked-in position, releasing the tie means L (FIG. 9) and in an extended or output position making winding possible (FIGS. 7 and 8). In a variant, not shown in the attached figures, when the rotary plate 3a constitutes a part of the shifting plate 2a, the rotary plate 3a may be fitted in the plate 2a so that it may furthermore be moved in translation transversally to the shifting plate 2a behind the latter to be able to retract the winding pins 3b, attached to the rotary plate 3a. The winding pins 3b no longer exceeding the shifting plate 2a.

Consequently, with the winding pins 3b in the retracted position, the tie means L in wound state may be released from the rotary plate 3a. During its release, the tie means may then drop by gravity into a container of the machine or onto the ground outside of the machine where it may be recovered by the operator.

The tie means L, in particular of the string-type, may be released from the double comb and in particular when the rotary plate 3a has already completed a few turns in order to wind the tie means L around the pins 3b. More specifically, with a grip means 1 in the form of a double comb and for a string-type tie means L, the tie means L does not need to be released or discharged from the double comb, i.e. by operating the latter to switch it from its grip or closed state to its expecting or open state, the tie means L sliding naturally between the teeth 10a, 10b of the two respective combs 1a, 1b due to the effect of winding. When the tie means L is of another form, for example of the net-type, the double comb 1a, 1b may be operated in the open state to release the tie means L.

With reference again to FIGS. 1 to 5, 8 and 9, one can see that the grip and removal device may also include sensing means 12 for the outer surface S of the bale B in order to detect the second position to reach for the grip means 1. Such sensing means 12 may consist of a mechanical sensor operating by contact with the outer surface S of the bale B when the grip means 1 moves from their first position to their second position.

The grip and removal device may include a control box or other control interface (shown in FIG. 1) connected functionally, particularly by the relevant actuators or drive elements such as the drive carriage 4b:
to the swiveling arms 6 to control their operation,
to the sensing device 12 in order to control the stop of the travel of the grip means 1 between its first position and its second position when the outer surface S of the bale B has been detected, indicating that the grip means 1 has reached its second position, enabling gripping of the tie means L,
to the shifting means 2 to control their travel,
where applicable, to the rotary plate 3a to control its rotation in order to carry out the winding of the tie means L,
where applicable, to the pins 3b or to the rotary plate 3a to control their output in order to release the wound tie means L.

The control box may include an electronic control unit U (shown schematically in FIG. 1), to manage the various functionalities of the device according to one or more scheduled sequences enabling all or part of the tie means L grip and removal operations to be controlled automatically. To enable such automation or sequencing, the machine and/or the grip and removal device is/are fitted with one or more sensing device(s). Such a sensing device includes, for example, at least one position sensor connected to the swiveling arm(s) 6, at least one presence sensor of the bale B on the receiving area P1, at least one presence sensor on at least one of the side walls C2, at least one position sensor on the double comb or on the actuator enabling the change in state of the grip element 1a, 1b, 1c. Thanks to the various sensors, the grip and removal device may be operated automatically in complete safety.

Where the machine, according to the present invention, is intended for the manufacturing of pellets, this may be of the fixed or stationary platform-type, configured/equipped, in a known manner, to enable a straw bale to be decompressed or shredded to make pellets. In such a machine, the platform is the receptacle C and the receiving area P1 is formed by part of the platform. This platform may have side walls C2, generally of a few centimeters. In one variant, the platform has no side walls C2.

The purpose of the present invention is also a method for gripping and removing the tie means L of a cylindrical or rectangular cuboid bale B loaded in a machine intended to load, shred, distribute and/or transform such a bale B. Such a machine, which includes a receptable C and a receiving area P1 on which such a bale B may rest, may be a machine, according to the present invention, described previously and suitable for the implementation of such a method.

The machine may be of the straw-bedder type or of the type for the manufacturing of pellets, used as a fuel source.

In accordance with the present invention, such a method involves, with a machine suitable for its implementation, following a cutting step of the tie means L:
moving the grip means 1 from a first position remote from the outer surface S of the bale B to a second position on the outer surface S where the tie means L extends, then to grip the tie means L using the grip means 1,
in a removal step: removing the tie means L from the bale B using the removal means by moving it away from the outer surface S of the bale B, and where applicable, before full removal, releasing the tie means L from the grip means 1.

The advantage of using such a method is the mechanized separation of the tie means L from the bale B. Such a method enables the tie means L to be at least gripped mechanically/automatically and to remove the tie means L from the bale B by moving it at least partially mechanically/automatically away from the latter, preferably completely (or totally). Productivity is therefore improved, as is the comfort of use for the operator.

It is understood that in the second position on the outer surface S, the grip means 1 may extend or penetrate into the thickness (or the thickness of the outer layer) of the bale B (FIGS. 3 and 4).

In the grip step, in the second position, the method may involve performing a change in state of the grip means 1 to bring it to switch from an expecting or open state to a grip or closed state thereby gripping the tie means L.

In the grip step, the method may involve gripping the tie means L by pinching, trapping, clamping or hooking.

In the removal step, the method may involve either removing the tie means L by shifting the latter onto or beyond one side of the receptacle C or of the machine, or by performing a preliminary shifting step involving shifting the tie means L onto or beyond one side of the receptacle C or of the machine and then (completely) removing the tie means L.

Still in the removal step, where applicable following the preliminary shifting step, the method may involve removing the tie means L from the bale B by winding of the latter. Preferably, winding is done around a winding axis X2, preferably horizontally and/or parallel to the bottom C1 of the receptacle C and/or parallel to the ground and/or transversally in relation to the direction of travel A and/or transversally in relation to the longitudinal axis X of the machine.

In a drop step, which may also be included in the method, following the removal step, the method may involve automatically releasing the tie means L from the removal means 3 and, where applicable, from the grip means 1, with a view to being able to automatically carry out its release or removal.

Of course, the invention is not limited to the embodiment described and shown in the attached drawings. Modifications remain possible, in particular concerning the composition of the various elements or by substituting technical equivalents without departing from the scope of protection of the invention.

1. Method for gripping and removing the tie means of a cylindrical or rectangular cuboid bale loaded in a machine intended to load, shred, distribute and/or transform such a bale, the machine including a receptacle and a receiving area on which such a bale rests, held in shape by a tie means extending around the outer surface of the bale, which involves, using such a machine furthermore including a device for gripping and removing the tie means, the device including a grip means and removal means, following a cutting step for the tie means:
in a grip step: moving the grip means from a first position remote from the outer surface of the bale to a second position on the outer surface where the tie means extends, then gripping the tie means using the grip means,
in a removal step: removing the tie means from the bale using the removal means by moving it away from the outer surface of the bale.

2. A method for gripping and removing according to claim 1, which involves, in the grip step, in the second position, performing a change in state of the grip means to switch it from an expecting state to a grip or closed state thereby carrying out the gripping of the tie means.

3. A method for gripping and removing according to claim 1, which involves, in the removal step, either removing the tie means by shifting the latter onto or beyond one side of the receptacle or of the machine, or by performing a preliminary shifting step involving shifting the tie means onto or beyond one side of the receptable or of the machine and then extracting the tie means.

4. A method for gripping and removing according to claim 1, which involves, in the removal step, where applicable following the preliminary shifting step, removing the tie means from the bale by winding it around a winding axis, preferably a horizontal winding axis.

5. Machine intended to load, shred, distribute and/or transform a cylindrical or rectangular cuboid bale held in shape by a tie means extending around the outer surface of the bale, the machine including a receptacle and a receiving area, which furthermore includes a device for gripping and removing the tie means, including:
a grip means configured to be able to grip the tie means of such a bale resting on the receiving area,
removal means configured to be able to act on the tie means in such a way as to be able to remove it from the bale by moving it away from the outer surface of the bale,
and being configured to be able to move the grip means above the receiving area between a first position enabling it to be moved away from the outer surface of the bale and a second position enabling it, in order to grip the tie means, to be positioned on the outer surface.

6. A machine according to claim 5, wherein the grip means is configured to be able to change state, so that it switches when operated from an expecting or open state to a grip or closed state and vice-versa, the grip or closed state making it possible to grip the tie means.

7. A machine according to claim 5, wherein the grip means is configured to grip the tie means by pinching, trapping, clamping or hooking.

8. A machine according to claim 5, wherein the grip means includes a one movable grip element able, when the grip means switches from the expecting state to the grip state, to be moved in translation, preferably in rectilinear translation or according to another trajectory, for example helical.

9. A machine according to claim 8, wherein the grip means includes a double comb featuring two combs fitted with teeth able to penetrate the thickness of the bale, the two combs extending parallel one behind the other, and one of the combs forming the or one of the movable grip element(s).

10. A machine according to claim 5, wherein the grip and removal device is fitted in an articulated manner on the receptacle and includes a joint featuring a swivel axis, preferably a horizontal swivel axis, and an arm, preferably two arms, pivoting around the or one of the swivel axes and carrying at least the grip means such that it may be moved into the first position and into the second position.

11. A machine according to claim 5, wherein the removal means include shifting means able to be moved and being configured so that they can, when moving, be applied against the tie means such that it is shifted onto or beyond one side of the receptacle or the machine.

12. A machine according to claim 11, wherein the removal means furthermore include a drive system making travel of the shifting means possible, the drive system including a drive carriage movable in translation, preferably in rectilinear translation, from one side to the other of the receptacle or of the machine and the shifting means are rigidly fastened to the carriage and, preferably, include guides that make it possible to collect, group and guide the tie means meeting the shifting means during their travel.

13. A machine according to claim 11, wherein the removal means furthermore include withdrawal means enabling the tie means to be removed from the bale, preferably by winding around a winding axis, preferably a horizontal winding axis.
